(19) United States
(12) Patent Application Publication
(10) Pub. No.: US 2020/0049955 A1
(43) Pub. Date: Feb. 13, 2020

(54) IMAGE CAPTURING APPARATUS

(71) Applicant: Gingy Technology Inc., Hsinchu City (TW)

(72) Inventors: Yi-Feng Chiu, Hsinchu City (TW); Chiung-Han Wang, Hsinchu City (TW); Jen-Chieh Wu, Hsinchu City (TW)

(73) Assignee: Gingy Technology Inc., Hsinchu City (TW)

(21) Appl. No.: 16/527,071

(22) Filed: Jul. 31, 2019

Related U.S. Application Data
(60) Provisional application No. 62/715,294, filed on Aug. 7, 2018.

(30) Foreign Application Priority Data
Dec. 17, 2018 (TW) 107217077
Mar. 20, 2019 (CN) 201910212362.X

(51) Int. Cl. G02B 13/00; G02B 9/12; G02B 5/20

(52) U.S. Cl. CPC G02B 13/0035; G02B 5/208; G02B 9/12

(57) ABSTRACT

An image capturing apparatus includes a cover plate, a first lens element, a second lens element, a third lens element and a sensor arranged sequentially from an object side to an image side along an optical axis. The number of lens elements in the image capturing apparatus is only three. The image capturing apparatus satisfies: f/imgH<0.45, and 2<(OTL-d)/imgH<9, wherein f is an effective focal length of the image capturing apparatus, imgH is a maximum image height of the image capturing apparatus, OTL is a distance from an object to an image plane on the optical axis, and d is a thickness of the cover plate.

### CROSS-REFERENCE TO RELATED APPLICATION

This application claims the priority benefits of U.S. provisional application Ser. No. 62/715,294, filed on Aug. 7, 2018, Taiwan application serial no. 107217077, filed on Dec. 17, 2018, and China application serial no. 201910212362.X, filed on Mar. 20, 2019. The entirety of each of the above-mentioned patent applications is hereby incorporated by reference herein and made a part of this specification.

### BACKGROUND OF THE INVENTION

### 1. Field of the Invention

The invention relates to an electronic apparatus, and more particularly, to an image capturing apparatus.

### 2. Description of Related Art

Most of the biometric systems in electronic devices on the market today adopt the principle of capacitance which can reduce a volume of the electronic device, and yet the complicated circuit structure also leads to high production costs and makes the product unit price high and difficult to popularize. At present, although there are some biometric systems adopting the principle of optical imaging (e.g., finger print recognition, palm print recognition or vein recognition), the existing optical imaging systems have the problem of over-large volume. Consequently, the electronic device cannot be easily miniaturized and thinned and thus the portability of the electronic device is poor. Therefore, how to reduce the volume of the optical imaging system in the electronic device while maintaining a preferable optical imaging quality has become an important goal of the current research and development in the industry.

### SUMMARY OF THE INVENTION

The invention provides an image capturing apparatus capable of realizing a thinning effect while maintaining the preferable optical imaging quality.

An image capturing apparatus of the invention includes a cover plate, a first lens element, a second lens element, a third lens element and a sensor arranged sequentially from an object side to an image side along an optical axis. The number of lens elements in the image capturing apparatus is only three. The image capturing apparatus satisfies: f/imgH<0.45, and 2<(OTL-d)/imgH<9, wherein f is an effective focal length of the image capturing apparatus, imgH is a maximum image height of the image capturing apparatus, OTL is a distance from an object to an image plane on the optical axis, and d is a thickness of the cover plate.

An image capturing apparatus of the invention includes a display panel, a lens assembly and a sensor. The lens assembly includes a first lens element having a negative refractive power, a second lens element having a positive refractive power, a third lens element having a negative refractive power and a storage component holding the first lens element, the second lens element and the third lens element therein. The display panel, the first lens element, the second lens element, the third lens element and the sensor are arranged sequentially from an object side to an image side along an optical axis.

Based on the above, the image capturing apparatus according to the embodiments of the invention can provide the following advantageous effect. By providing the cover plate together with optical parameter design and arrangement of the three lens elements, the image capturing apparatus may be manufactured easier, and an optical performance capable of overcoming aberrations can be maintained while reducing a thickness of the image capturing apparatus. Accordingly, the image capturing apparatus can realize the thinning effect while maintaining the preferable imaging quality.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an image capturing apparatus according to a first embodiment of the invention.

FIG. 2A to FIG. 2C are graphs showing a longitudinal spherical aberration and other aberrations of the image capturing apparatus according to the first embodiment.

FIG. 3 is a schematic diagram of an image capturing apparatus according to a second embodiment of the invention.

FIG. 4A to FIG. 4C are graphs showing a longitudinal spherical aberration and other aberrations of the image capturing apparatus according to the second embodiment.

FIG. 5 is a schematic diagram of an image capturing apparatus according to a third embodiment of the invention.

FIG. 6A to FIG. 6C are graphs showing a longitudinal spherical aberration and other aberrations of the image capturing apparatus according to the third embodiment.

FIG. 7 is a schematic diagram of an image capturing apparatus according to a fourth embodiment of the invention.

FIG. 8A to FIG. 8C are graphs showing a longitudinal spherical aberration and other aberrations of the image capturing apparatus according to the fourth embodiment.

FIG. 9 is a schematic diagram of an image capturing apparatus according to a fifth embodiment of the invention.

FIG. 10A to FIG. 10C are graphs showing a longitudinal spherical aberration and other aberrations of the image capturing apparatus according to the fifth embodiment.

FIG. 11 is a schematic diagram of an image capturing apparatus according to a sixth embodiment of the invention.

FIG. 12A to FIG. 12C are graphs showing a longitudinal spherical aberration and other aberrations of the image capturing apparatus according to the sixth embodiment.

FIG. 13 to FIG. 16 are schematic diagrams of image capturing apparatuses according to a seventh embodiment to a tenth embodiment of the invention.

### DESCRIPTION OF THE EMBODIMENTS

In the following embodiments, wordings used to indicate directions, such as “up”, “down”, “front”, “back”, “left” and “right”, merely refer to directions in the accompanying drawings. Therefore, the directional wording is used to illustrate rather than limit the disclosure. In the accompanying drawings, each drawing illustrates the general features of the methods, structures, and/or materials used in the specific exemplary embodiments. However, the drawings should not be construed as definition or limitation to the scope and property coveted by the specific exemplary embodiments. For instance, relative thicknesses and locations of film layers, regions or structures may be reduced or enlarged for clarity.

In the following embodiments, the same or similar reference numbers represent the same or similar elements, and repeated description thereof is omitted. In addition, features in the different exemplary embodiments can be combined with each other without conflict, and the simple equivalent changes and modifications made to the present specification or the scope of claims still fall within the scope of the invention. Further, the terms “first”, “second” and the like as recited in the specification or claims are intended to name discrete elements or distinguish different embodiments or scopes, and are not intended to limit an upper limit or a lower limit of the number of the elements nor limit a manufacturing order or a disposing order of the elements.

In the following embodiments, each image capturing apparatus is adapted to capture a biological feature of an object. For instance, when the object is a finger, the biological feature may be a finger print or a vein. When the object is a palm, the biological feature may be a palm print.

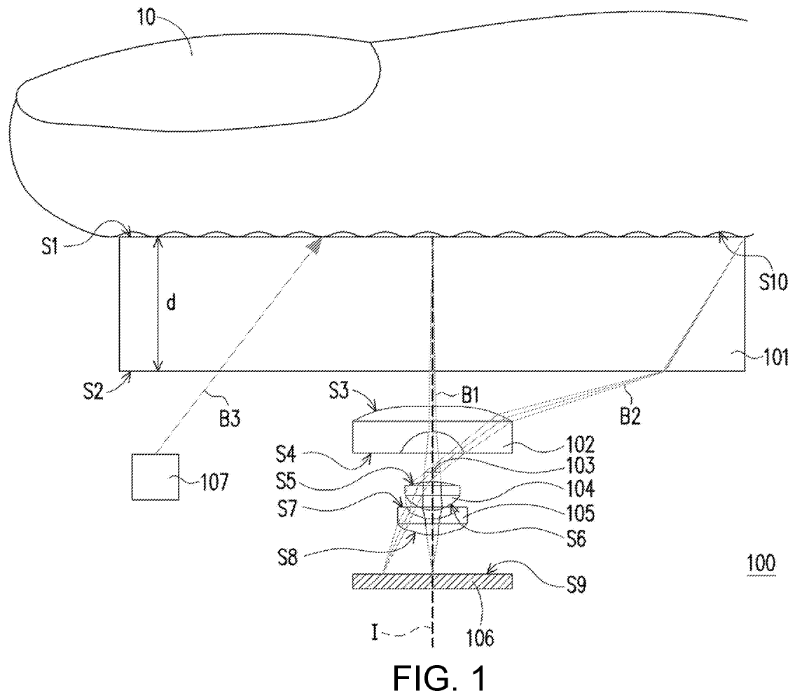

FIG. 1 is a schematic diagram of an image capturing apparatus according to a first embodiment of the invention. With reference to FIG. 1, an image capturing apparatus 100 in the first embodiment of the invention includes a cover plate 101, a first lens element 102, an aperture 103, a second lens element 104, a third lens element 105 and a sensor 106 arranged sequentially from an object side to an image side along an optical axis I. The object side is the side where an object 10 is located, and the image side is the side where an image plane S9 is located. In this disclosure, the image plane S9 is a sensing plane of the sensor 106 in the image capturing apparatus 100. When entering the image capturing apparatus 100, imaging light beams from the object 10 (i.e., light beams carrying information regarding the biological feature, such as an imaging light beam B1 and an imaging light beam B2) will be transmitted to the sensing plane (i.e., the image plane S9) of the sensor 106 after sequentially passing through the cover plate 101, the first lens element 102, the aperture 103, the second lens element 104 and the third lens element 105, so as to form an image on the image plane S9.

Each of the cover plate 101, the first lens element 102, the second lens element 104 and the third lens element 105 includes an object side surface (e.g., object side surfaces S1, S3, S5 and S7) and an image side surface (e.g., image side surfaces S2, S4, S6 and S8). The object side surface is a surface facing the object side (or the object 10) and allowing the imaging light beams to pass through, and the image side surface is a surface facing the image side (or the image plane S9) and allowing the imaging light beams to pass through.

The cover plate 101 is adapted to protect elements located therebelow. In this embodiment, the cover plate 101 is a finger pressure plate. During a biological feature recognition, the object side surface S1 of the cover plate 101 is a surface in contact with the object 10. In other words, the object 10 contacts the object side surface S1 of the cover plate 101 for the biological feature recognition. The finger pressure plate may include a body that is transparent or semi-transparent to facilitate the transmission of the imaging light beams to the sensor 106. The body may include a glass plate, a plastic plate or a combination of the two, but not limited thereto. In addition, the finger pressure plate may selectively include a decorative layer, and the decorative layer is disposed on the cover plate 101 to cover the elements therebelow that are not to be seen.

In another embodiment, the cover plate 101 may include a finger pressure plate, a display panel, a touch display panel or a combination of at least two of the above. For instance, the cover plate 101 may be the display panel, such as an organic light emitting display panel, but not limited thereto. Alternatively, the cover plate 101 may be the touch display panel, such as an organic light emitting display panel having a plurality of touch electrodes. The touch electrodes may be formed on an outer surface of the organic light emitting display panel or embedded in the organic light emitting display panel, and the touch electrodes may perform a touch detection by ways of self capacitance or mutual capacitance. Alternatively, the cover plate 101 may be a combination of the finger pressure plate and the display panel or a combination of the finger pressure plate and the touch display panel.

In addition, when the image capturing apparatus 100 is integrated together with a liquid crystal display (including a liquid crystal display panel and a backlight module), the cover plate 101 may be disposed above the liquid crystal display, or an opposite substrate in the liquid crystal display may be used as the cover plate 101 of the image capturing apparatus 100. The liquid crystal display may be formed with an opening for accommodating the optical imaging system (including the first lens element 102, the second lens element 104, the third lens element 105 and the sensor 106). The backlight module is located below the liquid crystal display panel to provide an illumination light beam. In order to prevent the illumination light beam transmitted from the backlight module from being directly transmitted to the sensor 106, a light shielding structure may be formed between the backlight module and the optical imaging system, so as to maintain a desired imaging quality. The touch electrodes may be further disposed under the above structure to provide a touch detection function.

The first lens element 102 is adapted to expand a field of view (FOV) of the image capturing apparatus 100 so the sensor 106 of the image capturing apparatus 100 can capture a greater image range. In this embodiment, the first lens element 102 has a negative refracting power. In addition, the object side surface S3 of the first lens element 102 near the optical axis is concave, and the image side surface S4 of the first lens element 102 near the optical axis is concave. In order to meet the requirements of lightweight, the first lens element 102 may be made of a plastic material, but is not limited thereto.

The aperture 103 is adapted to reduce a stray light and thereby improve an image quality. In this embodiment, the aperture 103 is disposed between the first lens element 102 and the second lens element 104 to help expanding the field of view so the image capturing apparatus 100 has the advantage of a wide-angle lens.

The second lens element 104 is adapted to correct an aberration produced by the first lens element 102 and help reducing spherical aberrations, so as to improve an imaging quality. In this embodiment, the second lens element 104 has a positive refracting power. In addition, the object side surface S5 of the second lens element 104 near the optical axis is convex, and the image side surface S6 of the second lens element 104 near the optical axis is convex. In order to meet the requirements of lightweight, the second lens element 104 may be made of a plastic material, but is not limited thereto.

The third lens element 105 is also adapted to correct the aberration and help reducing the spherical aberrations, so as to improve the imaging quality. In addition, by correcting the aberration with multiple lens elements (e.g., the second lens element 104 and the third lens element 105), other than effectively correcting the aberration, a manufacturing difficulty of each lens element for correcting the aberration may also be reduced. In this embodiment, the third lens element 105 has a negative refracting power. In addition, the object side surface S7 of the third lens element 105 near the optical axis is concave, and the image side surface S8 of the third lens element 105 near the optical axis is convex. In order to meet the requirements of lightweight, the third lens element 105 may be made of a plastic material, but is not limited thereto. In any exemplary embodiment of the invention, an infrared filtering material may be coated on the image side surface S8 of the third lens element 105. Alternatively, an infrared light filtering layer (not illustrated) may be disposed between the third lens element 105 and the second lens element 104. Alternatively, an infrared light filtering layer (not illustrated) may be disposed between the third lens element 105 and the image plane S9.

The sensor 106 is adapted to receive the imaging light beams transmitted from the object 10. In this embodiment, the sensor 106 may be, for example, a charge coupled device (CCD) or a complementary metal oxide semiconductor (CMOS), which are not particularly limited by the invention.

In the image capturing apparatus 100, only the first lens element 102, the second lens element 104 and the third lens element 105 have the refracting power, and only the three lens elements in the image capturing apparatus 100 have the refracting power. In other words, the number of lens elements in the image capturing apparatus 100 is only three.

Detailed optical data in the first embodiment is as shown in Table 1.

TABLE 1
f = 0.221 mm, Fno = 1.96, HFOV = 68°, imgH = 0.7 mm

| | | Radius of | | | | |
|---|---|---|---|---|---|---|
| | | Curvature | Distance | Refractive | Coefficient | Focal length |
| | Surface | (mm) | (mm) | Index | of dispersion | (mm) |
| Object 10 | Surface S10 | | 0 | | | |
| Cover | Object side | Infinite | 1.800 | 1.52 | 64.2 | |
| plate 101 | surface S1 | | | | | |
| | Image side | Infinite | 0.565 | | | |
| | surface S2 | | | | | |
| First lens | Object side | −6125.69 | 0.343 | 1.64 | 21.5 | −0.64 |
| element 102 | surface S3 | | | | | |
| | Image side | 0.412 | 0.577 | | | |
| | surface S4 | | | | | |
| Aperture 103 | | Infinite | 0.125 | | | |
| Second lens | Object side | 0.311 | 0.403 | 1.64 | 21.5 | 0.34 |
| element 104 | surface S5 | | | | | |
| | Image side | −0.366 | 0.117 | | | |
| | surface S6 | | | | | |
| Third lens | Object side | −0.616 | 0.223 | 1.64 | 21.5 | −1.52 |
| element 105 | surface S7 | | | | | |
| | Image side | −1.886 | 0.545 | | | |
| | surface S8 | | | | | |
| Sensor 106 | Image plane S9 | Infinite | | | | |

### In Table 1:

f is an effective focal length (EFL) of the image capturing apparatus 100;
Fno is an f-number of the image capturing apparatus 100, i.e., f/EPD, wherein EPD is an entrance pupil diameter of the image capturing apparatus 100;
HFOV is a half field of view (HFOV), i.e., half of the FOV;
imgH is a maximum image height of the image capturing apparatus 100 (i.e., half of a diagonal length of an effective photo sensing region of the sensor 106 of the image capturing apparatus 100).
“Radius of Curvature (mm)” being “Infinite” indicates that the corresponding surface is a plane.
“Distance (mm)” represents a distance from the corresponding surface to the next surface on the optical axis I. For instance, “Distance (mm)” of the object 10 being 0 indicates that a distance from the surface S10 of the object 10 facing the cover plate 101 to the object side surface S1 of the cover plate 101 on the optical axis I is 0 mm. “Distance (mm)” of the object side surface S1 of the cover plate 101 being 1.800 indicates that a distance from the object side surface S1 of the cover plate 101 to the image side surface S2 of the cover plate 101 on the optical axis I is 1.800 mm. “Distance (mm)” of the image side surface S8 of the third lens element 105 being 0.565 indicates that a distance from the image side surface S8 of the third lens element 105 to the image plane S9 of the sensor 106 on the optical axis I is 0.565 mm. The other fields may be deduced by analogy, and thus not repeated hereinafter.

In this embodiment, the object side surface S3 of the first lens element 102, the image side surface S4 of the first lens element 102, the object side surface S5 of the second lens element 104, the image side surface S6 of the second lens element 104, the object side surface S7 of the third lens element 105 and the image side surface S8 of the third lens element 105 are aspheric surfaces. The aspheric surface is defined by Formula (1) below:

$$Z ( Y ) = \frac{{Y}^{2}}{R} \text{/} ( 1 + \sqrt{1 - ( 1 + K ) \frac{{Y}^{2}}{{R}^{2}}} ) + {\sum }_{i = 1}^{n} {a}_{i} \times {Y}^{i} \qquad ( 1 )$$

### In Formula (1):

Y represents a vertical distance from a point on the aspheric surface to the optical axis I;
Z represents a depth of the aspheric surface (a vertical distance between the point on the aspheric surface spaced from the optical axis I by the distance Y and a tangent plane tangent to a vertex of the aspheric surface on the optical axis I);
R represents a radius of curvature of the surface of the lens element near the optical axis;
K represents a conic constant;
aᵢ represents an i^{th} aspheric coefficient.

Various aspheric coefficients of the object side surface S3 of the first lens element 102, the image side surface S4 of the first lens element 102, the object side surface S5 of the second lens element 104, the image side surface S6 of the second lens element 104, the object side surface S7 of the third lens element 105 and the image side surface S8 of the third lens element 105 in Formula (1) are as shown in Table 2.

TABLE 2

| | Lens | | | | | |
|---|---|---|---|---|---|---|
| | First lens element 102 | | Second lens element 104 | | Third lens element 105 | |
| | Surface | | | | | |
| | Object side | Image side | Object side | Image side | Object side | Image side |
| | surface S3 | surface S4 | surface S5 | surface S6 | surface S7 | surface S8 |
| K | 850 | −0.373 | −904 | −0.771 | −911 | −877 |
| a₂ | 0.146 | −0.0618 | 16 | −15 | −71.2 | −26.6 |
| a₃ | −0.003 | −7.146 | −394 | 458 | 2070 | 415 |
| a₄ | −0.0077 | 1.87 | 6230 | −4312 | −28000 | −2660 |
| a₅ | −0.0004 | 188 | −58790 | 4320 | 169000 | 5840 |
| a₆ | 0.0008 | 280 | 291000 | 159000 | 66600 | 12200 |
| a₇ | 0.0002 | −611 | −464900 | −868000 | −6170000 | −82100 |
| a₈ | −0.0001 | −10800 | −852000 | 1280000 | 21600000 | 113000 |

A relationship between the important parameters in the image capturing apparatus 100 of the first embodiment is as shown in Table 3.

TABLE 3

| Condition | Value |
|---|---|
| f/imgH | 0.3156 |
| N1 + N2 + N3 | 4.92 |
| OTL (mm) | 4.698 |
| d (mm) | 1.8 |
| OTL − d (mm) | 2.898 |
| (OTL − d)/imgH | 4.14 |
| V1 + V2 + V3 | 64.5 |
| \|f/f1\| + \|f/f2\| + \|f/f3\| | 1.147 |
| FOV (degree) | 136 |

### In Table 3:

N1 is a refractive index of the first lens element 102;
N2 is a refractive index of the second lens element 104;
N3 is a refractive index of the third lens element 105;
OTL is a distance from the object 10 to the image plane S9 on the optical axis I, and is also a distance from the object side surface S1 of the cover plate 101 to the image plane S9 on the optical axis I;
d is a thickness of the cover plate 101;
V1 is a coefficient of dispersion of the first lens element 102, and the coefficient of dispersion is also known as Abbe number;
V2 is a coefficient of dispersion of the second lens element 104;
V3 is a coefficient of dispersion of the third lens element 105;
f1 is a focal length of the first lens element 102;
f2 is a focal length of the second lens element 104;
f3 is a focal length of the third lens element 105.

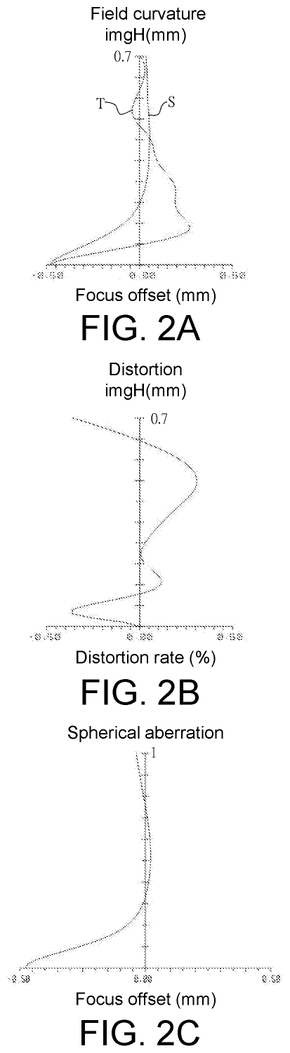

FIG. 2A to FIG. 2C are graphs showing a longitudinal spherical aberration and other aberrations of the image capturing apparatus according to the first embodiment. FIG. 2A illustrates a field curvature aberration in the sagittal direction and a field curvature aberration in the tangential direction on the image plane S9 when the wavelength is 550 nm. Here, the field curvature aberrations in the sagittal direction and in the tangential direction are represented by a curve S and a curve T, respectively. FIG. 2B illustrates a distortion aberration on the image plane S9 when the wavelength is 550 nm. FIG. 2C illustrates a longitudinal spherical aberration when the wavelength is 550 nm and a pupil radius is 0.0577 mm. As can be seen from FIG. 2A to FIG. 2C, the image capturing apparatus 100 of the first embodiment can significantly improve the spherical aberration, effectively eliminate the aberration, and maintain the distortion aberrations within the requirements of the imaging quality. Accordingly, the image capturing apparatus 100 of the first embodiment can achieve the preferable imaging quality while realizing the thinning effect (OTL is reduced to 4.698 mm).

Based on different requirements, the image capturing apparatus 100 may further include other elements/film layers, or omit the elements/film layers in FIG. 1. For instance, the image capturing apparatus 100 may further include a light source 107 to provide a light beam B3 for irradiating the object 10. The light source 107 is disposed below the cover plate 101. In other words, the light source 107, the first lens element 102, the aperture 103, the second lens element 104, the third lens element 105 and the sensor 106 are located on the same side of the cover plate 101.

The light source 107 may be a visible light source. For instance, a wavelength of the light source 107 is between 400 nm and 600 nm, but not limited thereto. Alternatively, the light source 107 may be an invisible light source, such as an infrared light source. In another embodiment, when the image capturing apparatus 100 is installed with a display module, a part of display light beams emitted by the display module may be used in the biological feature recombination so that the light source 107 can be omitted. In yet another embodiment, when the cover plate 101 is the display panel, a part of display light beams emitted by the display panel may be used in the biological feature recombination so that the light source 107 can also be omitted. In still another embodiment, when the cover plate 101 is the display panel, the light source 107 may be disposed below the display panel and the light source 107 is the invisible light source such as the infrared light source.

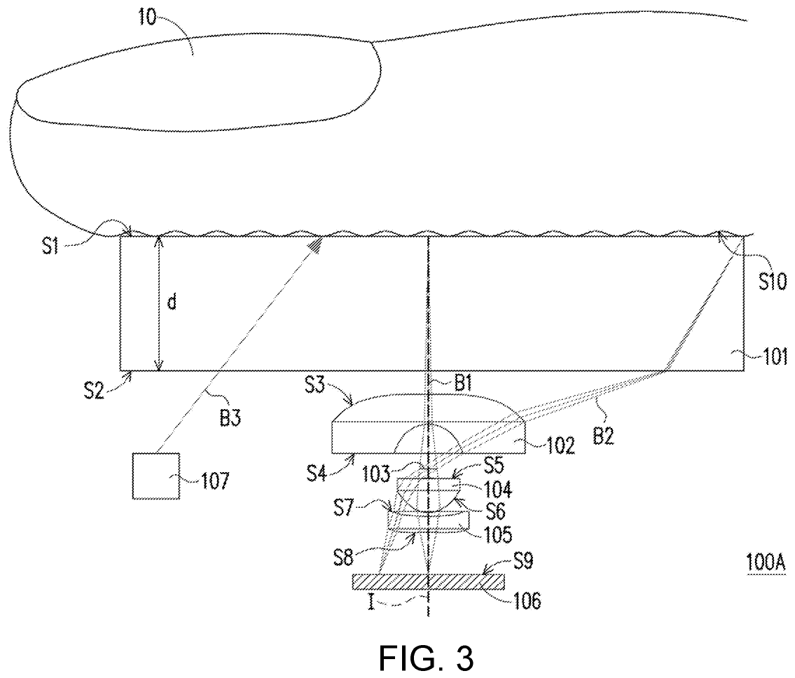

FIG. 3 is a schematic diagram of an image capturing apparatus according to a second embodiment of the invention. With reference to FIG. 3, an image capturing apparatus 100A of the second embodiment differs from the image capturing apparatus 100 of FIG. 1 in that, the optical data, the aspheric coefficients, and the parameters of the lens elements in these embodiments are different to some extent. In addition, the object side surface S1 of the first lens element 102 near the optical axis is convex, and the image side surface S8 of the third lens element 105 near the optical axis is concave.

Detailed optical data in the second embodiment is as shown in Table 4.

TABLE 4
f = 0.258 mm, Fno = 2.05, HFOV = 66°, imgH = 0.68 mm

| | | Radius of | | | | |
|---|---|---|---|---|---|---|
| | | Curvature | Distance | Refractive | Coefficient | Focal length |
| | Surface | (mm) | (mm) | Index | of dispersion | (mm) |
| Object 10 | Surface S10 | | 0 | | | |
| Cover | Object side | Infinite | 1.800 | 1.52 | 64.2 | |
| plate 101 | surface S1 | | | | | |
| | Image side | Infinite | 0.408 | | | |
| | surface S2 | | | | | |
| First lens | Object side | 1473.993 | 0.423 | 1.64 | 21.5 | −0.68 |
| element 102 | surface S3 | | | | | |
| | Image side | 0.442 | 0.626 | | | |
| | surface S4 | | | | | |
| Aperture 103 | | Infinite | 0.127 | | | |
| Second lens | Object side | 0.629 | 0.482 | 1.64 | 21.5 | 0.42 |
| element 104 | surface S5 | | | | | |
| | Image side | −0.333 | 0.053 | | | |
| | surface S6 | | | | | |
| Third lens | Object side | −2.413 | 0.223 | 1.64 | 21.5 | −3.09 |
| element 105 | surface S7 | | | | | |
| | Image side | 12.075 | 0.591 | | | |
| | surface S8 | | | | | |
| Sensor 106 | Image plane S9 | Infinite | | | | |

The aspheric coefficients of the object side surface and the image side surface of each lens element in Formula (1) in the second embodiment are as shown in Table 5.

TABLE 5

| | Lens | | | | | |
|---|---|---|---|---|---|---|
| | First lens element 102 | | Second lens element 104 | | Third lens element 105 | |
| | Surface | | | | | |
| | Object side | Image side | Object side | Image side | Object side | Image side |
| | surface S3 | surface S4 | surface S5 | surface S6 | surface S7 | surface S8 |
| K | −853 | −0.397 | −861 | −0.6322 | −73.3 | −845 |
| a₂ | 0.128 | 0.546 | −0.8044 | 1.26 | −0.263 | −0.498 |
| a₃ | 0.00081 | −3.813 | 8.89 | −2.69 | −0.574 | −0.525 |
| a₄ | −0.00569 | 6.72 | −25.15 | 11.8 | −1.98 | 0.471 |
| a₅ | −0.00006 | 193 | −159.1 | 30.6 | −4.53 | 1.7 |
| a₆ | 0.00111 | 325 | 839 | −103.2 | −13.8 | 2.36 |
| a₇ | 0.0002 | −552.7 | −3200 | −62.1 | −34 | −5.38 |
| a₈ | −0.00006 | −10540 | 203 | 775 | −73.9 | −74.4 |

A relationship between the important parameters of the second embodiment is as shown in Table 6.

TABLE 6

| Condition | Value |
|---|---|
| f/imgH | 0.3806 |
| N1 + N2 + N3 | 4.92 |
| OTL (mm) | 4.733 |
| d (mm) | 1.8 |
| OTL − d (mm) | 2.933 |
| (OTL − d)/imgH | 4.313 |
| V1 + V2 + V3 | 64.5 |
| \|f/f1\| + \|f/f2\| + \|f/f3\| | 1.078 |
| FOV (degree) | 132 |

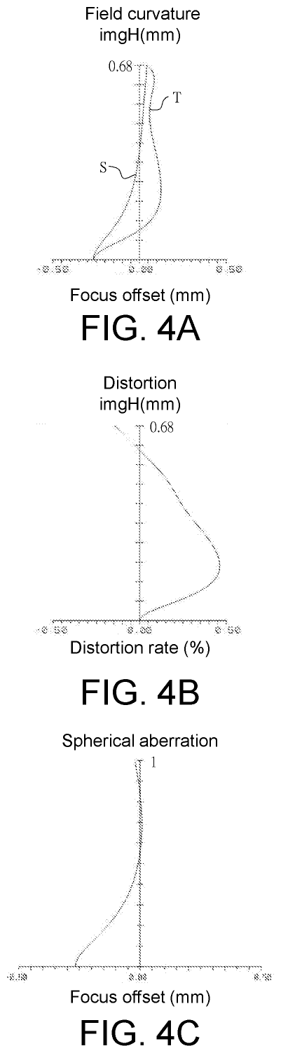

FIG. 4A to FIG. 4C are graphs showing a longitudinal spherical aberration and other aberrations of the image capturing apparatus according to the second embodiment. FIG. 4A illustrates a field curvature aberration in the sagittal direction and a field curvature aberration in the tangential direction on the image plane S9 when the wavelength is 550 nm. FIG. 4B illustrates a distortion aberration on the image plane S9 when the wavelength is 550 nm. FIG. 4C illustrates a longitudinal spherical aberration when the wavelength is 550 nm and the pupil radius is 0.0629 mm. As can be seen from FIG. 4A to FIG. 4C, the image capturing apparatus 100A of the second embodiment can significantly improve the spherical aberration, effectively eliminate the aberration, and maintain the distortion aberrations within the requirements of the imaging quality. Accordingly, the image capturing apparatus 100A of the second embodiment can achieve the preferable imaging quality while realizing the thinning effect (OTL is reduced to 4.733 mm).

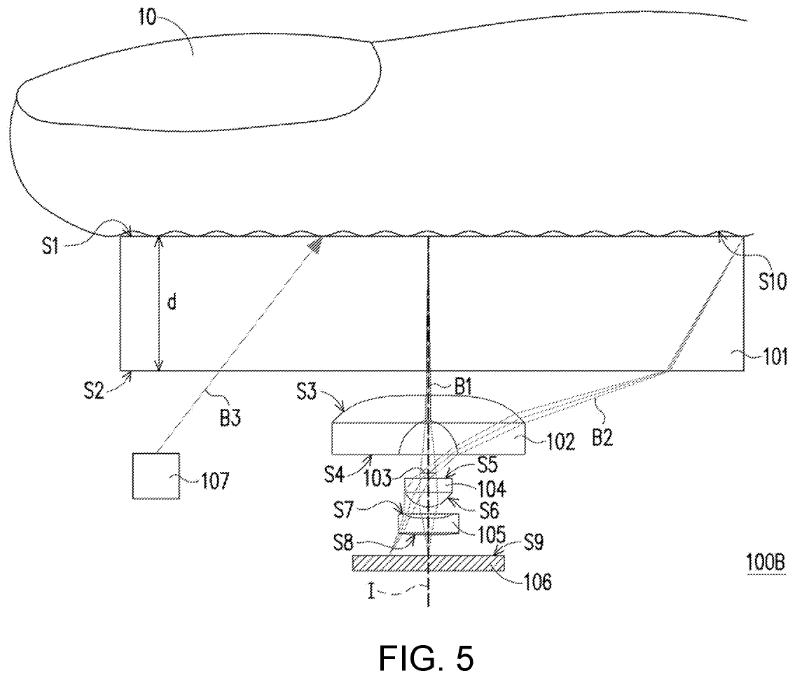

FIG. 5 is a schematic diagram of an image capturing apparatus according to a third embodiment of the invention. With reference to FIG. 5, an image capturing apparatus 100B of the third embodiment differs from the image capturing apparatus 100 of FIG. 1 in that, the optical data, the aspheric coefficients, and the parameters of the lens elements in these embodiments are different to some extent. In addition, the object side surface S1 of the first lens element 102 near the optical axis is convex, and the image side surface S8 of the third lens element 105 near the optical axis is concave.

Detailed optical data in the third embodiment is as shown in Table 7.

TABLE 7
f = 0.218 mm, Fno = 2.6, HFOV = 68°, imgH = 0.54 mm

| | | Radius of | | | | |
|---|---|---|---|---|---|---|
| | | Curvature | Distance | Refractive | Coefficient | Focal length |
| | Surface | (mm) | (mm) | Index | of dispersion | (mm) |
| Object 10 | Surface S10 | | 0 | | | |
| Cover | Object side | Infinite | 1.800 | 1.52 | 64.2 | |
| plate 101 | surface S1 | | | | | |
| | Image side | Infinite | 0.317 | | | |
| | surface S2 | | | | | |
| First lens | Object side | 6.954 | 0.381 | 1.64 | 21.5 | −0.45 |
| element 102 | surface S3 | | | | | |
| | Image side | 0.274 | 0.736 | | | |
| | surface S4 | | | | | |
| Aperture 103 | | Infinite | 0.064 | | | |
| Second lens | Object side | 1.271 | 0.411 | 1.64 | 21.5 | 0.41 |
| element 104 | surface S5 | | | | | |
| | Image side | −0.288 | 0.159 | | | |
| | surface S6 | | | | | |
| Third lens | Object side | −1.507 | 0.230 | 1.64 | 21.5 | −1.43 |
| element 105 | surface S7 | | | | | |
| | Image side | 2.545 | 0.296 | | | |
| | surface S8 | | | | | |
| Sensor 106 | Image plane S9 | Infinite | | | | |

The aspheric coefficients of the object side surface and the image side surface of each lens element in Formula (1) in the third embodiment are as shown in Table 8.

TABLE 8

| | Lens | | | | | |
|---|---|---|---|---|---|---|
| | First lens element 102 | | Second lens element 104 | | Third lens element 105 | |
| | Surface | | | | | |
| | Object side | Image side | Object side | Image side | Object side | Image side |
| | surface S3 | surface S4 | surface S5 | surface S6 | surface S7 | surface S8 |
| K | 22.9 | −0.546 | −256 | −0.706 | 14.5 | −756 |
| a₂ | 0.0723 | −1.66 | 5.99 | 2.1 | 0.00456 | −2.096 |
| a₃ | 0.01 | 0.0142 | −141.8 | −4.33 | −4.88 | 0.864 |
| a₄ | −0.00776 | −3.2 | −1290 | −8.64 | −15.2 | 42.32 |
| a₅ | 0.00387 | −202 | 9880 | −420 | 176.5 | −47.2 |
| a₆ | −0.0003 | −48.7 | 0 | −5830 | 1610 | −176 |
| a₇ | −0.00004 | 334 | 0 | −51800 | −10710 | −742 |
| a₈ | −0.00004 | 43000 | 0 | −150000 | −260000 | −179 |

A relationship between the important parameters of the third embodiment is as shown in Table 9.

TABLE 9

| Condition | Value |
|---|---|
| f/imgH | 0.4037 |
| N1 + N2 + N3 | 4.92 |
| OTL (mm) | 4.394 |
| d (mm) | 1.8 |
| OTL − d (mm) | 2.594 |
| (OTL − d)/imgH | 4.804 |
| V1 + V2 + V3 | 64.5 |
| \|f/f1\| + \|f/f2\| + \|f/f3\| | 1.174 |
| FOV (degree) | 136 |

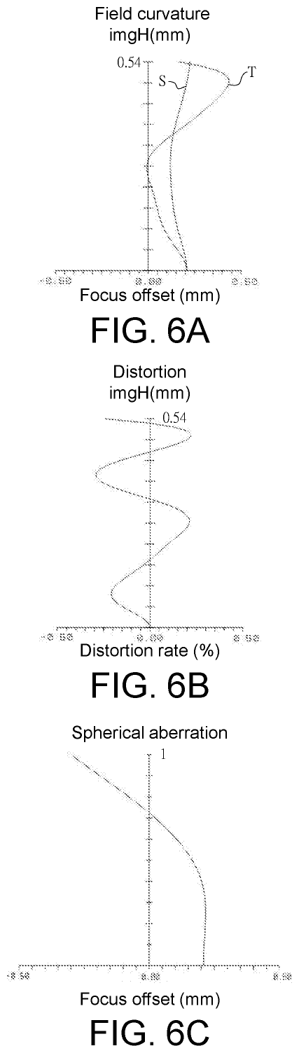

FIG. 6A to FIG. 6C are graphs showing a longitudinal spherical aberration and other aberrations of the image capturing apparatus according to the third embodiment. FIG. 6A illustrates a field curvature aberration in the sagittal direction and a field curvature aberration in the tangential direction on the image plane S9 when the wavelength is 550 nm. FIG. 6B illustrates a distortion aberration on the image plane S9 when the wavelength is 550 nm. FIG. 6C illustrates a longitudinal spherical aberration when the wavelength is 550 nm and the pupil radius is 0.0422 mm. As can be seen from FIG. 6A to FIG. 6C, the image capturing apparatus 100B of the third embodiment can significantly improve the spherical aberration, effectively eliminate the aberration, and maintain the distortion aberrations within the requirements of the imaging quality. Accordingly, the image capturing apparatus 100B of the third embodiment can achieve the preferable imaging quality while realizing the thinning effect (OTL is reduced to 4.394 mm).

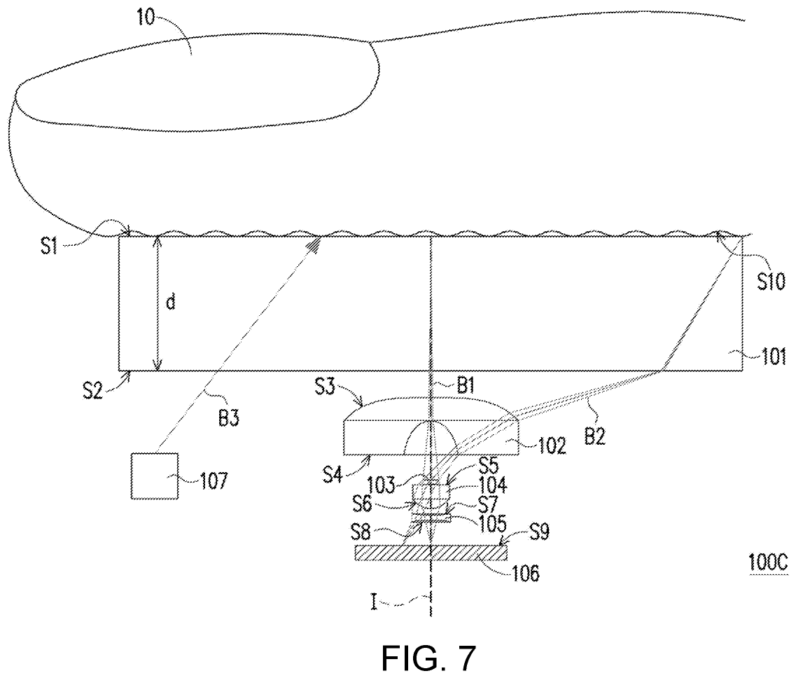

FIG. 7 is a schematic diagram of an image capturing apparatus according to a fourth embodiment of the invention. With reference to FIG. 7, an image capturing apparatus 100C of the fourth embodiment differs from the image capturing apparatus 100 of FIG. 1 in that, the optical data, the aspheric coefficients, and the parameters of the lens elements in these embodiments are different to some extent. In addition, the object side surface S1 of the first lens element 102 near the optical axis is convex, and the image side surface S8 of the third lens element 105 near the optical axis is concave.

Detailed optical data in the fourth embodiment is as shown in Table 10.

TABLE 10
f = 0.186 mm, Fno = 2.6, HFOV = 68°, imgH = 0.44 mm

| | | Radius of | | | | |
|---|---|---|---|---|---|---|
| | | Curvature | Distance | Refractive | Coefficient | Focal length |
| | Surface | (mm) | (mm) | Index | of dispersion | (mm) |
| Object 10 | Surface S10 | | 0 | | | |
| Cover | Object side | Infinite | 1.800 | 1.52 | 64.2 | |
| plate 101 | surface S1 | | | | | |
| | Image side | Infinite | 0.647 | | | |
| | surface S2 | | | | | |
| First lens | Object side | 59.322 | 0.366 | 1.64 | 21.5 | −0.43 |
| element 102 | surface S3 | | | | | |
| | Image side | 0.275 | 0.897 | | | |
| | surface S4 | | | | | |
| Aperture 103 | | Infinite | 0.062 | | | |
| Second lens | Object side | 0.923 | 0.371 | 1.64 | 21.5 | 0.37 |
| element 104 | surface S5 | | | | | |
| | Image side | −0.279 | 0.100 | | | |
| | surface S6 | | | | | |
| Third lens | Object side | −4.714 | 0.076 | 1.64 | 21.5 | −1.06 |
| element 105 | surface S7 | | | | | |
| | Image side | 0.809 | 0.385 | | | |
| | surface S8 | | | | | |
| Sensor 106 | Image plane S9 | Infinite | | | | |

The aspheric coefficients of the object side surface and the image side surface of each lens element in Formula (1) in the fourth embodiment are as shown in Table 11.

TABLE 11

| | Lens | | | | | |
|---|---|---|---|---|---|---|
| | First lens element 102 | | Second lens element 104 | | Third lens element 105 | |
| | Surface | | | | | |
| | Object side | Image side | Object side | Image side | Object side | Image side |
| | surface S3 | surface S4 | surface S5 | surface S6 | surface S7 | surface S8 |
| K | 723 | −0.549 | −78.1 | −0.5 | −846 | −852 |
| a₂ | 0.107 | −2.88 | −1.22 | 3.07 | −31 | −13.1 |
| a₃ | 0 | 0 | 0 | 0 | 1140 | 459.7 |
| a₄ | 0 | 0 | 0 | 0 | −18200 | −4410 |
| a₅ | 0 | 0 | 0 | 0 | 142000 | 11000 |
| a₆ | 0 | 0 | 0 | 0 | −438500 | 34300 |
| a₇ | 0 | 0 | 0 | 0 | 0 | 0 |
| a₈ | 0 | 0 | 0 | 0 | 0 | 0 |

A relationship between the important parameters of the fourth embodiment is as shown in Table 12.

TABLE 12

| Condition | Value |
|---|---|
| f/imgH | 0.4227 |
| N1 + N2 + N3 | 4.92 |
| OTL (mm) | 4.704 |
| d (mm) | 1.8 |
| OTL − d (mm) | 2.904 |
| (OTL − d)/imgH | 6.6 |
| V1 + V2 + V3 | 64.5 |
| \|f/f1\| + \|f/f2\| + \|f/f3\| | 1.102 |
| FOV (degree) | 136 |

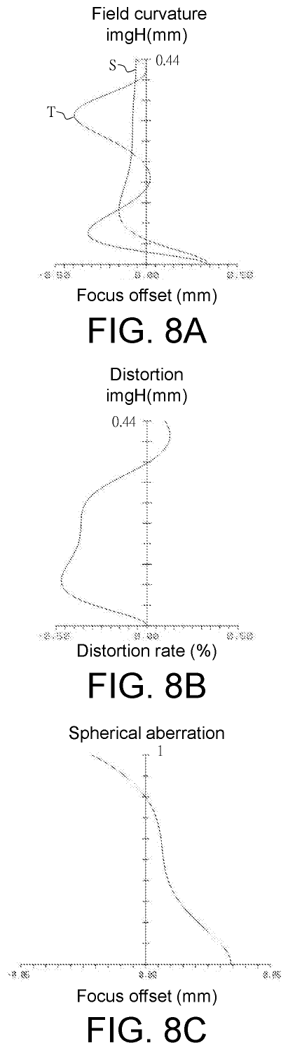

FIG. 8A to FIG. 8C are graphs showing a longitudinal spherical aberration and other aberrations of the image capturing apparatus according to the fourth embodiment. FIG. 8A illustrates a field curvature aberration in the sagittal direction and a field curvature aberration in the tangential direction on the image plane S9 when the wavelength is 550 nm. FIG. 8B illustrates a distortion aberration on the image plane S9 when the wavelength is 550 nm. FIG. 8C illustrates a longitudinal spherical aberration when the wavelength is 550 nm and the pupil radius is 0.039 mm. As can be seen from FIG. 8A to FIG. 8C, the image capturing apparatus 100C of the fourth embodiment can significantly improve the spherical aberration, effectively eliminate the aberration, and maintain the distortion aberrations within the requirements of the imaging quality. Accordingly, the image capturing apparatus 100C of the fourth embodiment can achieve the preferable imaging quality while realizing the thinning effect (OTL is reduced to 4.704 mm).

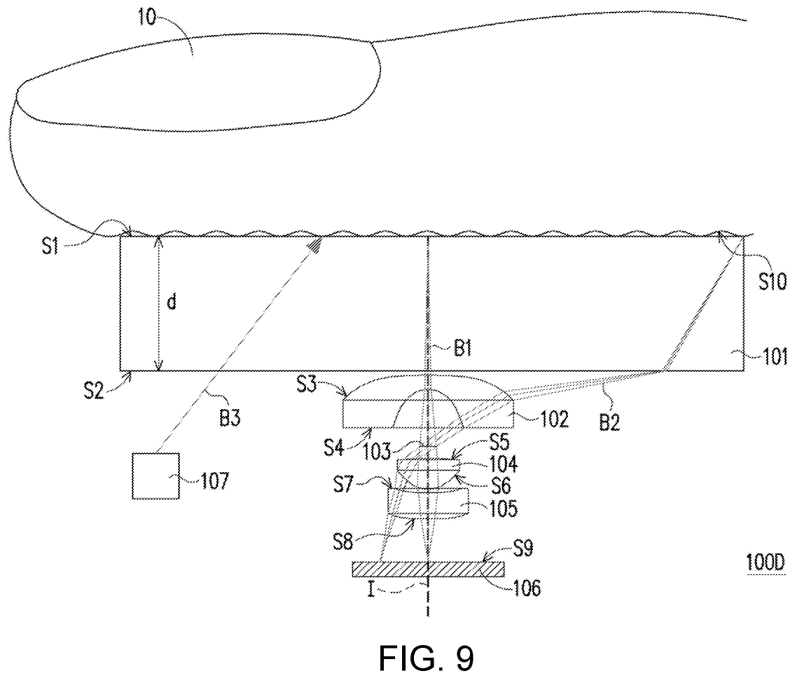

FIG. 9 is a schematic diagram of an image capturing apparatus according to a fifth embodiment of the invention. With reference to FIG. 9, an image capturing apparatus 100D of the fifth embodiment differs from the image capturing apparatus 100 of FIG. 1 in that, the optical data, the aspheric coefficients, and the parameters of the lens elements in these embodiments are different to some extent. In addition, the object side surface S1 of the first lens element 102 near the optical axis is convex.

Detailed optical data in the fifth embodiment is as shown in Table 13.

TABLE 13
f = 0.2599 mm, Fno = 2.6, HFOV = 68°, imgH = 0.7 mm

| | | Radius of | | | | |
|---|---|---|---|---|---|---|
| | | Curvature | Distance | Refractive | Coefficient | Focal length |
| | Surface | (mm) | (mm) | Index | of dispersion | (mm) |
| Object 10 | Surface S10 | | 0 | | | |
| Cover | Object side | Infinite | 1.800 | 1.52 | 64.2 | |
| plate 101 | surface S1 | | | | | |
| | Image side | Infinite | 0.063 | | | |
| | surface S2 | | | | | |
| First lens | Object side | 25.144 | 0.199 | 1.64 | 21.5 | −0.75 |
| element 102 | surface S3 | | | | | |
| | Image side | 0.476 | 0.795 | | | |
| | surface S4 | | | | | |
| Aperture 103 | | Infinite | 0.157 | | | |
| Second lens | Object side | 0.65 | 0.434 | 1.64 | 21.5 | 0.45 |
| element 104 | surface S5 | | | | | |
| | Image side | −0.396 | 0.051 | | | |
| | surface S6 | | | | | |
| Third lens | Object side | −2.504 | 0.360 | 1.64 | 21.5 | −6.88 |
| element 105 | surface S7 | | | | | |
| | Image side | −6.049 | 0.598 | | | |
| | surface S8 | | | | | |
| Sensor 106 | Image plane S9 | Infinite | | | | |

The aspheric coefficients of the object side surface and the image side surface of each lens element in Formula (1) in the fifth embodiment are as shown in Table 14.

TABLE 14

| | Lens | | | | | |
|---|---|---|---|---|---|---|
| | First lens element 102 | | Second lens element 104 | | Third lens element 105 | |
| | Surface | | | | | |
| | Object side | Image side | Object side | Image side | Object side | Image side |
| | surface S3 | surface S4 | surface S5 | surface S6 | surface S7 | surface S8 |
| K | 183 | −0.374 | −858 | −0.44 | −55 | −802 |
| a₂ | 0.184 | 3.198 | 0.421 | −0.416 | −0.443 | −0.494 |
| a₃ | −0.0519 | −8.11 | 9.31 | 7.74 | 0.946 | −0.08381 |
| a₄ | 0.0198 | 2.75 | −90.56 | 15 | −2.3 | 0.228 |
| a₅ | −0.00206 | 119 | 284 | 23.2 | −13.5 | −0.3824 |
| a₆ | −0.00158 | 380 | −301 | 135 | −2.842 | −0.687 |
| a₇ | 0.00069 | −134 | −381 | −482 | −7.94 | −3.11 |
| a₈ | −0.00016 | −7480 | −824 | −5940 | −203.6 | 1.2 |

A relationship between the important parameters of the fifth embodiment is as shown in Table 15.

TABLE 15

| Condition | Value |
|---|---|
| f/imgH | 0.3713 |
| N1 + N2 + N3 | 4.92 |
| OTL (mm) | 4.457 |
| d (mm) | 1.8 |
| OTL − d (mm) | 2.657 |
| (OTL − d)/imgH | 3.796 |
| V1 + V2 + V3 | 64.5 |
| \|f/f1\| + \|f/f2\| + \|f/f3\| | 0.962 |
| FOV (degree) | 136 |

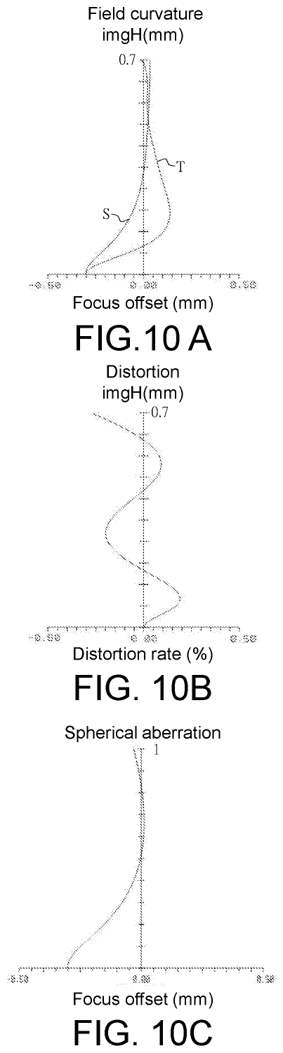

FIG. 10A to FIG. 10C are graphs showing a longitudinal spherical aberration and other aberrations of the image capturing apparatus according to the fifth embodiment. FIG. 10A illustrates a field curvature aberration in the sagittal direction and a field curvature aberration in the tangential direction on the image plane S9 when the wavelength is 550 nm. FIG. 10B illustrates a distortion aberration on the image plane S9 when the wavelength is 550 nm. FIG. 10C illustrates a longitudinal spherical aberration when the wavelength is 550 nm and the pupil radius is 0.0585 mm. As can be seen from FIG. 10A to FIG. 10C, the image capturing apparatus 100D of the fifth embodiment can significantly improve the spherical aberration, effectively eliminate the aberration, and maintain the distortion aberrations within the requirements of the imaging quality. Accordingly, the image capturing apparatus 100D of the fifth embodiment can achieve the preferable imaging quality while realizing the thinning effect (OTL is reduced to 4.457 mm).

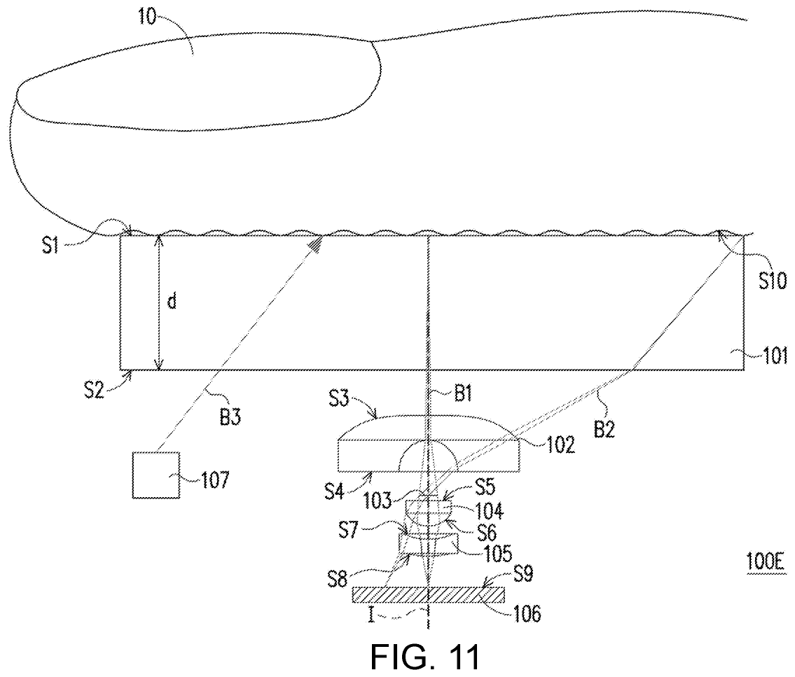

FIG. 11 is a schematic diagram of an image capturing apparatus according to a sixth embodiment of the invention. With reference to FIG. 11, an image capturing apparatus 100E of the sixth embodiment differs from the image capturing apparatus 100 of FIG. 1 in that, the optical data, the aspheric coefficients, and the parameters of the lens elements in these embodiments are different to some extent. In addition, the object side surface S1 of the first lens element 102 near the optical axis is convex.

Detailed optical data in the sixth embodiment is as shown in Table 16.

TABLE 16
f = 0.242 mm, Fno = 2.5, HFOV = 68°, imgH = 0.57 mm

| | | Radius of | | | | |
|---|---|---|---|---|---|---|
| | | Curvature | Distance | Refractive | Coefficient | Focal length |
| | Surface | (mm) | (mm) | Index | of dispersion | (mm) |
| Object 10 | Surface S10 | | 0 | | | |
| Cover | Object side | Infinite | 1.800 | 1.52 | 64.2 | |
| plate 101 | surface S1 | | | | | |
| | Image side | Infinite | 0.607 | | | |
| | surface S2 | | | | | |
| First lens | Object side | 17.312 | 0.339 | 1.64 | 21.5 | −0.49 |
| element 102 | surface S3 | | | | | |
| | Image side | 0.308 | 0.738 | | | |
| | surface S4 | | | | | |
| Aperture 103 | | Infinite | 0.067 | | | |
| Second lens | Object side | 1.733 | 0.343 | 1.64 | 21.5 | 0.44 |
| element 104 | surface S5 | | | | | |
| | Image side | −0.317 | 0.174 | | | |
| | surface S6 | | | | | |
| Third lens | Object side | −0.686 | 0.229 | 1.58 | 21.5 | −14.21 |
| element 105 | surface S7 | | | | | |
| | Image side | −0.840 | 0.419 | | | |
| | surface S8 | | | | | |
| Sensor 106 | Image plane S9 | Infinite | | | | |

The aspheric coefficients of the object side surface and the image side surface of each lens element in Formula (1) in the sixth embodiment are as shown in Table 17.

TABLE 17

| | Lens | | | | | |
|---|---|---|---|---|---|---|
| | First lens element 102 | | Second lens element 104 | | Third lens element 105 | |
| | Surface | | | | | |
| | Object side | Image side | Object side | Image side | Object side | Image side |
| | surface S3 | surface S4 | surface S5 | surface S6 | surface S7 | surface S8 |
| K | −850 | −0.375 | −825 | −0.289 | −1.93 | −10.8 |
| a₂ | 0.174 | −3.106 | −0.901 | 1 | 0.37 | 0.288 |
| a₃ | −0.142 | 0.0597 | −77.8 | −4.86 | −2.56 | 6.283 |
| a₄ | 0.0026 | 44.6 | −80.7 | −1.92 | 68.5 | −4.02 |
| a₅ | −0.0005 | −41.5 | −512 | 42.7 | 4.62 | 33.52 |
| a₆ | 0.00081 | −467 | 148000 | −2690 | 128.7 | 176 |
| a₇ | 0 | 0 | 0 | 0 | 0 | 0 |
| a₈ | 0 | 0 | 0 | 0 | 0 | 0 |

A relationship between the important parameters of the sixth embodiment is as shown in Table 18.

TABLE 18

| Condition | Value |
|---|---|
| f/imgH | 0.42456 |
| N1 + N2 + N3 | 4.86 |
| OTL (mm) | 4.716 |
| d (mm) | 1.8 |
| OTL − d (mm) | 2.916 |
| (OTL − d)/imgH | 5.116 |
| V1 + V2 + V3 | 64.5 |
| \|f/f1\| + \|f/f2\| + \|f/f3\| | 1.061 |
| FOV (degree) | 136 |

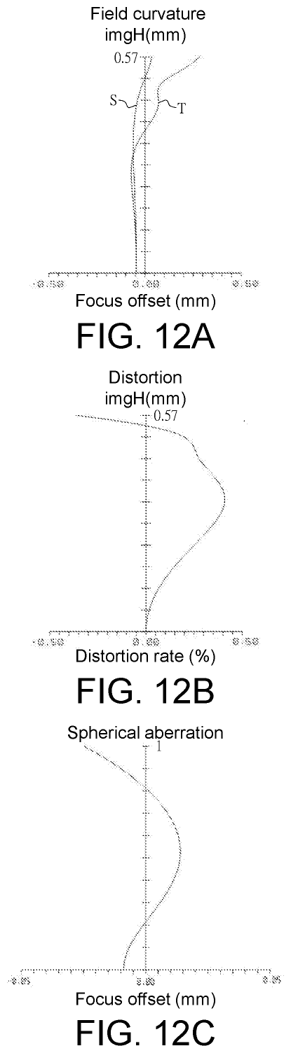

FIG. 12A to FIG. 12C are graphs showing a longitudinal spherical aberration and other aberrations of the image capturing apparatus according to the sixth embodiment. FIG. 12A illustrates a field curvature aberration in the sagittal direction and a field curvature aberration in the tangential direction on the image plane S9 when the wavelength is 550 nm. FIG. 12B illustrates a distortion aberration on the image plane S9 when the wavelength is 550 nm. FIG. 12C illustrates a longitudinal spherical aberration when the wavelength is 550 nm and the pupil radius is 0.0481 mm. As can be seen from FIG. 12A to FIG. 12C, the image capturing apparatus 100E of the sixth embodiment can significantly improve the spherical aberration, effectively eliminate the aberration, and maintain the distortion aberrations within the requirements of the imaging quality. Accordingly, the image capturing apparatus 100E of the sixth embodiment can achieve the preferable imaging quality while realizing the thinning effect (OTL is reduced to 4.716 mm).

In each of the embodiments of the invention, a preferable setting with the manufacture difficulty, the manufacturing process cost, the overall thickness and the imaging quality all taken into consideration can be obtained if at least one of the following conditions is satisfied.

f/imgH<0.45;

4.5<N1+N2+N3<5.4;

2<(OTL-d)/imgH<9;

Fno<3.7 or f/EPD<3.7;

(OTL-d)<3.5 mm;

V1+V2+V3<75;

0.7<|f/f1|+|f/f2|+|f/f3|<1.7;

100°<FOV<180°; and

the distance from the image side surface S8 of the third lens element 105 to the image plane S9 on the optical axis I is greater than 0.29 mm.

Specifically, by satisfying f/imgH<0.45, light beams in large-angle may be collected so the image capturing apparatus can capture the greater image range in a short distance. By satisfying 4.5<N1+N2+N3<5.4, the volume of the image capturing apparatus may be reduced to realize the thinning effect. By satisfying at least one of 2<(OTL-d)/imgH<9 and (OTL-d)<3.5 mm, the thinning effect may be realized. By satisfying Fno<3.7 or f/EPD<3.7, a larger aperture may be obtained. Accordingly, a preferable imaging effect can still be provided in an environment with insufficient light. By satisfying V1+V2+V3<75, a chromatic aberration may be corrected. By satisfying 0.7<|f/f1|+|f/f2|+|f/f3|<1.7, not only can the aberration be effectively corrected, a sensitivity of the optical system to the environment may also be reduced. By satisfying 100°<FOV<180°, a desired imaging range may be obtained and a degree of the distortion may be properly controlled.

Due to the unpredictability in an optical system design, with the framework set forth in the invention, the reduced thickness, the enlarged available aperture, the improved imaging quality, or the improved assembly yield can be achieved for the optical system of the invention to improve the shortcomings of the related art if at least one of aforementioned conditions can be satisfied.

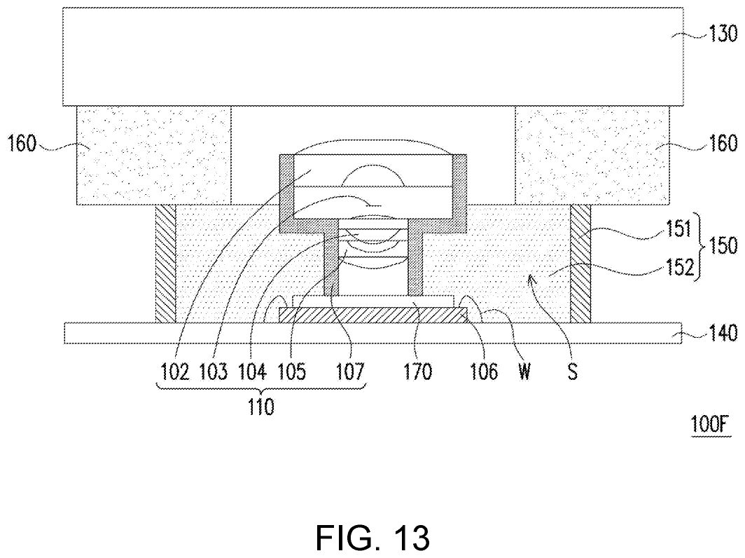

FIG. 13 to FIG. 16 are schematic diagrams of image capturing apparatuses according to a seventh embodiment to a tenth embodiment of the invention. With reference to FIG. 13, an image capturing apparatus 100F in the seventh embodiment of the invention includes a display panel 130, a lens assembly 110 and the sensor 106. The display panel 130 may be an organic light emitting display panel, but not limited thereto. In addition to the first lens element 102, the second lens element 104 and the third lens element 105 described above, the lens assembly 110 further includes a storage component 107 holding the first lens element 102, the second lens element 104 and the third lens element 105 therein. The storage component 107 may be a barrel, but not limited thereto. The shape or appearance of the storage component 107 may be changed according to design requirements, such as the sizes of the lens elements, but not limited thereto. The display panel 130, the first lens element 102, the second lens element 104, the third lens element 105 and the sensor 106 are arranged sequentially from an object side to an image side along an optical axis (not shown in FIG. 13, please refer to FIG. 1).

In the embodiment, the image capturing apparatus 100F may further include a carrier 140, a fixing element 150, a connection element 160 and a filter 170. The lens assembly 110, the sensor 106 and the filter 170 are disposed on the carrier 140, wherein the sensor 106 is located between the lens assembly 110 and the carrier 140, and the filter 170 is located between the lens assembly 110 and the sensor 106. For example, the sensor 106 may be fixed on the carrier 140 through an adhesive layer (not shown), the filter 170 may be fixed on the sensor 106 through an adhesive layer (not shown), and the lens assembly 110 may be fixed on the filter 170 through an adhesive layer (not shown), but not limited thereto. For example, the filtering material of the filter 170 may be coated on the sensor 106. The filtering material of the filter 170 may be an infrared filtering material, but not limited thereto.

The carrier 140 may include a circuit board, and the sensor 106 may be electrically connected to the carrier 140 (the circuit board) through wires W formed by a wire bonding process.

The fixing element 150 secures the lens assembly 110, the sensor 106 and the filter 170 on the carrier 140. For example, the fixing element 150 may include a frame 151 and an adhesive 152. The frame 151 surrounds the lens assembly 110, the sensor 106 and the filter 170. The adhesive 152 is disposed between the frame 151 and the lens assembly 110, between the frame 151 and the sensor 106 and between the frame 151 and the filter 170. Specifically, the frame 151 may be formed by curing a glue, and the adhesive 152 may be formed by curing an adhesive material which is filled into a space S defined by the frame 151 and flush with the frame 151. The adhesive 152 not only protects the wires W but also provides a plane for carrying the connection element 160.

The connection element 160 is connected between the display panel 130 and the fixing element 150. In the embodiment, the connection element 160 contacts the frame 151 and the adhesive 152. For example, the connection element 160 may be fixed to the display panel 130 and the fixing element 150 respectively through adhesive layers (not shown), but not limited thereto. Moreover, the connection element 160 may include shielding layers (not shown), a middle frame (not shown), adhesive layers (not shown), or at least two of the above.

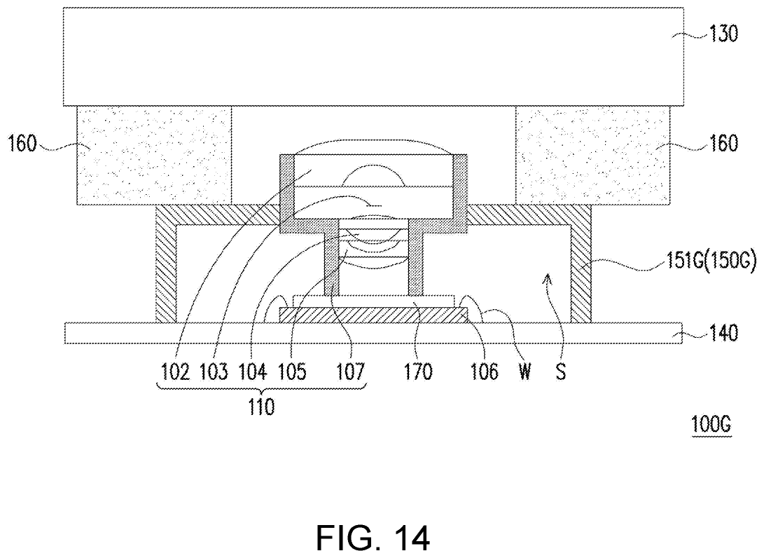

With reference to FIG. 14, an image capturing apparatus 100G of an eighth embodiment differs from the image capturing apparatus 100F of FIG. 13 in that, the fixing element 150G includes a frame 151G in contact with the connection element 160, and the fixing element 150G does not include the adhesive 152 in FIG. 13. The frame 151G may be an outer frame made of metal or plastic. Besides, the frame 151G may be fixed to the carrier 140 through a structure like an engaging structure or a spiral structure, and an adhesive material (such as a photo curing adhesive, a heat curing adhesive or a silicon resin) may be selectively disposed at corners between the frame 151G and the carrier 140. In the case where the adhesive material is not disposed at corners between the frame 151G and the carrier 140, the frame 151G is detachable from the carrier 140.

In the embodiment, the frame 151G not only protects the wires W but also provides a plane for carrying the connection element 160.

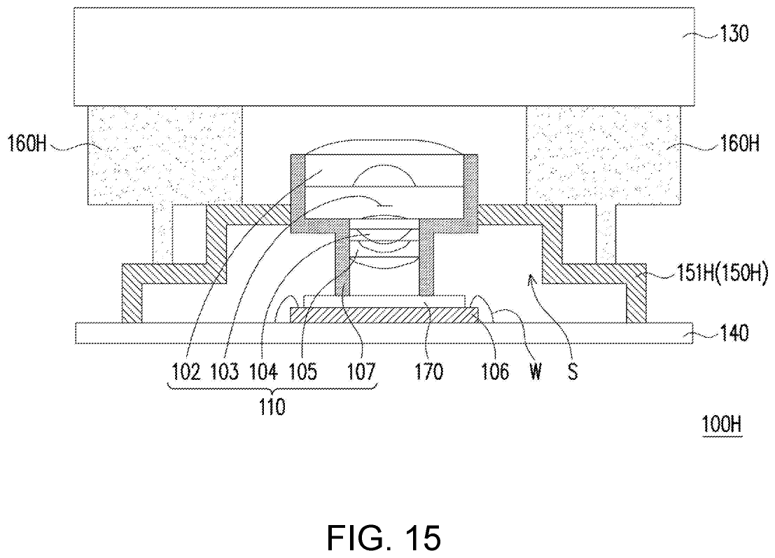

With reference to FIG. 15, an image capturing apparatus 100H of a ninth embodiment differs from the image capturing apparatus 100G of FIG. 14 in that, the frame 151H of the fixing element 150H provides a plurality of planes for carrying the connection element 160H. Specifically, by changing the shapes of the frame 151H and the connection element 160H, the frame 151H and the connection element 160H may have more contact areas.

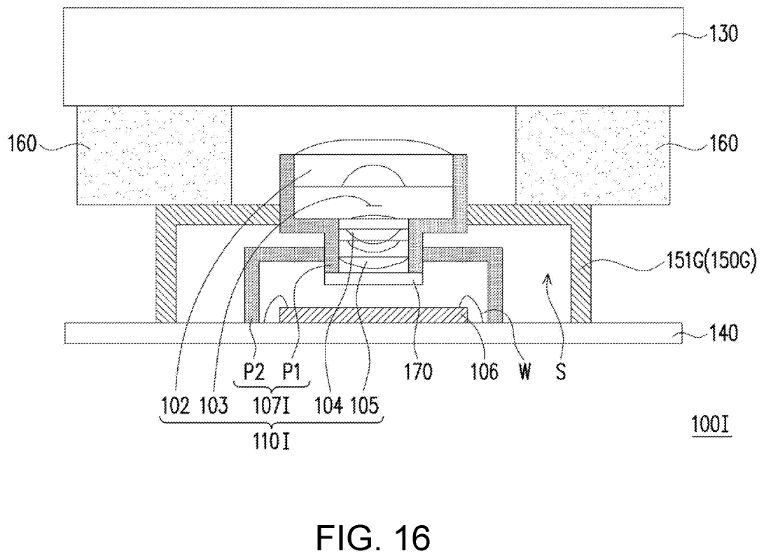

With reference to FIG. 16, an image capturing apparatus 100I of a tenth embodiment differs from the image capturing apparatus 100G of FIG. 14 in that, the storage component 107I of the lens assembly 110I has a first portion P1 holding the first lens element 102, the second lens element 104 and the third lens element 105 therein and a second portion P2 connecting the first portion P1 with the carrier 140. The first portion P1 may be a barrel, and the second portion P2 may be a holder, but not limited thereto. The second portion P2 may be fixed to the carrier 140 through a structure like an engaging structure or a spiral structure, and an adhesive material (such as a photo curing adhesive, a heat curing adhesive or a silicon resin) may be selectively disposed at corners between the second portion P2 and the carrier 140. In the case where the adhesive material is not disposed at corners between the second portion P2 and the carrier 140, the lens assembly 110I is detachable from the carrier 140. Alternatively, the second portion P2 may be firmly fixed to the carrier 140 through an adhesive material.

In view of above, the image capturing apparatus according to the embodiments of the invention has at least one of the following advantages or effects.

1. As compared to the light beam reflected by the object and captured by two or fewer lens elements, the light beam reflected by the object and captured by the three lens elements can help correcting the aberration and reducing the manufacturing difficulty of the lens elements.

2. The object side surface and the image side surface of each of the three lens elements adopting the design of the aspheric surface can help reducing the aberration.

3. The image capturing apparatus with the three lens elements can help collecting the light beams in large-angle, thereby allowing the image capturing apparatus to receive the image in larger range. Moreover, the distance from the object to the image capturing apparatus may also be reduced to effectively reduce the volume of the image capturing apparatus and realize the thinning effect.

4. The distance from the image side surface of the third lens element to the image plane on the optical axis is greater than 0.29 mm. With such design, elements/film layers, such as a light filtering element, may be disposed between the third lens element and the imaging plane, but is not limited thereto.

5. The aperture may be selectively disposed to reduce the stray light and thereby improve the image quality. In an embodiment, the aperture disposed between the first lens element and the second lens element can help expanding the field of view so the image capturing apparatus has the advantage of the wide-angle lens.

6. The longitudinal spherical aberrations, the field curvature aberrations, and the distortion aberrations in each embodiment of the invention all comply with usage specifications.

7. In the exemplary threshold conditions listed above, values below the maximum value or above the minimum value may be used to implement the invention. Optionally, any number of the exemplary threshold conditions may be combined and applied to implementation of the invention.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. An image capturing apparatus comprising a display panel, a lens assembly and a sensor, the lens assembly comprising a first lens element having a negative refractive power, a second lens element having a positive refractive power, a third lens element having a negative refractive power and a storage component holding the first lens element, the second lens element and the third lens element therein, wherein the display panel, the first lens element, the second lens element, the third lens element and the sensor are arranged sequentially from an object side to an image side along an optical axis.

2. The image capturing apparatus according to claim 1, further comprising:
a carrier;
a fixing element securing the lens assembly and the sensor on the carrier; and
a connection element connected between the display panel and the fixing element.

3. The image capturing apparatus according to claim 2, wherein the carrier includes a circuit board.

4. The image capturing apparatus according to claim 2, wherein the fixing element includes a frame and an adhesive, the frame surrounds the lens assembly and the sensor, the adhesive is disposed between the frame and the lens assembly and between the frame and the sensor, and the connection element contacts the frame and the adhesive.

5. The image capturing apparatus according to claim 2, wherein the fixing element includes a frame in contact with the connection element.

6. The image capturing apparatus according to claim 2, wherein the storage component has a first portion holding the first lens element, the second lens element and the third lens element therein and a second portion connecting the first portion with the carrier.

7. The image capturing apparatus according to claim 1, wherein the image capturing apparatus satisfies:
f/imgH<0.45; and
2<(OTL-d)/imgII<9,
wherein f is an effective focal length of the image capturing apparatus, imgH is a maximum image height of the image capturing apparatus, OTL is a distance from an object to an image plane on the optical axis, and d is a thickness of the display panel.

8. The image capturing apparatus according to claim 1, wherein each of the first lens element, the second lens element and the third lens element has an object side surface and an image side surface, the object side surface of the first lens element, the image side surface of the first lens element, the object side surface of the second lens element, the image side surface of the second lens element, the object side surface of the third lens element and the image side surface of the third lens element are aspheric surfaces, and the image capturing apparatus further comprises:
an aperture, disposed between the first lens element and the second lens element.

9. The image capturing apparatus according to claim 1, wherein the image capturing apparatus further satisfies:
(OTL-d)<3.5 mm,
wherein OTL is a distance from an object to an image plane on the optical axis, and d is a thickness of the display panel.

10. The image capturing apparatus according to claim 1, wherein a refractive index of the first lens element is N1, a refractive index of the second lens element is N2, a refractive index of the third lens element is N3, and the image capturing apparatus further satisfies:
4.5<N1+N2+N3<5.4.

11. The image capturing apparatus according to claim 1, wherein a coefficient of dispersion of the first lens element is V1, a coefficient of dispersion of the second lens element is V2, a coefficient of dispersion of the third lens element is V3, and the image capturing apparatus further satisfies:
V1+V2+V3<75.

12. The image capturing apparatus according to claim 1, wherein an effective focal length of the image capturing apparatus is f, an entrance pupil diameter of the image capturing apparatus is EPD, and the image capturing apparatus further satisfies:
f/EPD<3.7.

13. The image capturing apparatus according to claim 1, wherein an effective focal length of the image capturing apparatus is f, a focal length of the first lens element is f1, a focal length of the second lens element is f2, a focal length of the third lens element is f3, and the image capturing apparatus further satisfies:
$$0.7 < \vert \frac{f}{f 1} \vert + \vert \frac{f}{f 2} \vert + \vert \frac{f}{f 3} \vert < 1.7 .$$

14. The image capturing apparatus according to claim 1, wherein a field of view of the image capturing apparatus is FOV, and the image capturing apparatus further satisfies:
100°<FOV<180°.

15. The image capturing apparatus according to claim 1, wherein a distance from an image side surface of the third lens element to an image plane on the optical axis is greater than 0.29 mm.

16. The image capturing apparatus according to claim 1, further comprising:
a filter disposed between the lens assembly and the sensor.

17. An image capturing apparatus comprising a cover plate, a first lens element, a second lens element, a third lens element and a sensor arranged sequentially from an object side to an image side along an optical axis, wherein a number of lens elements in the image capturing apparatus is only three, and the image capturing apparatus satisfies:
f/imgII<0.45; and
2<(OTL-d)/imgH<9,
wherein f is an effective focal length of the image capturing apparatus, imgH is a maximum image height of the image capturing apparatus, OTL is a distance from an object to an image plane on the optical axis, and d is a thickness of the cover plate.

18. The image capturing apparatus according to claim 17, wherein refractive powers of the first lens element, the second lens element and the third lens element are negative, positive and negative, respectively, each of the first lens element, the second lens element and the third lens element has an object side surface and an image side surface, the object side surface of the first lens element, the image side surface of the first lens element, the object side surface of the second lens element, the image side surface of the second lens element, the object side surface of the third lens element and the image side surface of the third lens element are aspheric surfaces, and the image capturing apparatus further comprises:
an aperture disposed between the first lens element and the second lens element.

19. The image capturing apparatus according to claim 17, further satisfies
(OTL-d)<3.5 mm.

20. The image capturing apparatus according to claim 17, wherein a refractive index of the first lens element is N1, a refractive index of the second lens element is N2, a refractive index of the third lens element is N3, and the image capturing apparatus further satisfies:
4.5<N1+N2+N3<5.4.

21. The image capturing apparatus according to claim 17, wherein a coefficient of dispersion of the first lens element is V1, a coefficient of dispersion of the second lens element is V2, a coefficient of dispersion of the third lens element is V3, and the image capturing apparatus further satisfies:
V1+V2+V3<75.

22. The image capturing apparatus according to claim 17, wherein an entrance pupil diameter of the image capturing apparatus is EPD, and the image capturing apparatus further satisfies:
f/EPD<3.7.

23. The image capturing apparatus according to claim 17, wherein a focal length of the first lens element is f1, a focal length of the second lens element is f2, a focal length of the third lens element is f3, and the image capturing apparatus further satisfies:
$$0.7 < \vert \frac{f}{f 1} \vert + \vert \frac{f}{f 2} \vert + \vert \frac{f}{f 3} \vert < 1.7 .$$

24. The image capturing apparatus according to claim 17, wherein a field of view of the image capturing apparatus is FOV, and the image capturing apparatus further satisfies:
100°<FOV<180°.

25. The image capturing apparatus according to claim 17, wherein a distance from the image side surface of the third lens element to the image plane on the optical axis is greater than 0.29 mm.

26. The image capturing apparatus according to claim 17, further comprises:
a light source, disposed below the cover plate, and a wavelength of the light source is between 400 nm and 600 nm.

27. The image capturing apparatus according to claim 17, wherein the cover plate comprises a finger pressure plate, a display panel, a touch display panel or a combination of at least two of the above.
